(19) United States
(12) Patent Application Publication
(10) Pub. No.: US 2008/0157453 A1
(43) Pub. Date: Jul. 3, 2008

(54) Clamping jaws and clamping device for clamping workpieces

(75) Inventor: Hans-Michael Weller, Marbach (DE)

Correspondence Address: AKERMAN SENTERFITT, P.O. BOX 3188, WEST PALM BEACH, FL, 33402-3188, US

(73) Assignee: Hainbuch GmbH Spannende Technik, Marbach (DE)

(21) Appl. No.: 11/437,895

(22) Filed: May 19, 2006

Related U.S. Application Data
(63) Continuation of application No. PCT/EP04/12706, filed on Nov. 10, 2004.

(30) Foreign Application Priority Data
Nov. 21, 2003 (DE) DE 103 55 555.2

(51) Int. Cl. B25B 1/00

(52) U.S. Cl. 269/152

(57) ABSTRACT

The invention relates to a clamping device (11) comprising clamping jaws (13) in which a plurality of clamping rods (16) are disposed. The clamping rods (16) are enabled to move by means of an interlinked system of rod chambers (22) and channels (24, 28) in which a magnetorheological fluid (26) is contained. If a magnetic field is applied by means of a magnet (30), the fluid solidifies, the liquid-carrying connection between the rod chambers (22) is interrupted and the rods (16) are fixed in a defined position.

### FIELD OF APPLICATION AND PRIOR ART

The invention relates to a clamping jaw according to the preamble of claim 1 and to a clamping device having such a clamping jaw.

It is e.g. known from DE 42 39 180 A1 that for machining purposes sometimes very irregular and in part mechanically sensitive workpieces have to be clamped. This is not possible with a rigidly constructed, solid clamping jaw with an invariable clamping side. For this purpose clamping devices in accordance with DE 42 39 180 A1 have been created having a plurality of elongated clamping rods, which are longitudinally displaceable and which can be applied to a random contour of a workpiece as the clamping side. The clamping rods can be locked in a randomly set position. For this purpose it is inter alia possible to link them with chambers of a hydraulic fluid-filled, communicating system. Through fitted valves it is possible to interrupt the fluid line in the system for each clamping rod and in this way the clamping rods are locked in one position. Further similar clamping jaws with random, shape-variable clamping side are known from EP 899 061 A2 and DE 196 31 847.

It is disadvantageous that several valves are required, namely corresponding to the number of clamping rods. This makes such clamping jaws expensive to manufacture and in particular very complicated and costly to maintain, because large numbers of valves are naturally relatively fault-prone.

### Problem and Solution

The problem of the invention is to provide such a clamping jaw and such a clamping device with which it is possible to avoid the disadvantages of the prior art and in particular provide an easily manufacturable and maintainable clamping device, which is able to block a fluid line without movable parts.

This problem is solved by a clamping jaw having the features of claim 1 and a clamping device having the features of claim 18. Advantageous and preferred developments of the invention are given in further claims and are explained in greater detail hereinafter. By express reference the wording of the claims is made into part of the content of the description.

According to the invention a clamping jaw for a clamping device is provided in order to clamp a workpiece having a random shape. The clamping jaw has a body and a clamping side, which is applied to the workpiece to be clamped. The clamping side is formed by at least one and advantageously several clamping rods displaceable relative to the body and this can be applied to the contour of the workpiece to be clamped in order to secure it in a fixed position. The clamping rod is displaceable in a rod guide and can be fixed by a locking device. The locking device has a working fluid, which flows from a rod chamber through a channel and via a fluid path to a further rod chamber. The rod chamber undergoes a volume modification through a clamping rod movement and is in particular made larger on extraction and made smaller on insertion. For locking the clamping rod the channel or fluid path is constricted or blocked. This restricts or blocks the volume variability of the rod chamber and in this way the clamping rod is locked. The working fluid is constituted by a magnetorheological fluid. The locking ing device has a magnetic field production acting on the channel or fluid path.

If a magnetic field is produced, the characteristics of the magnetorheological fluid is such that the viscosity rises very greatly and it becomes virtually rigid. Thus, it can no longer flow within the system and the latter so-to-speak solidifies, the particular clamping rod being locked by the blocked volume variability of the rod chamber.

Such-magnetorheological fluids are e.g. known from U.S. Pat. No. 5,667,715 and U.S. Pat. No. 6,267,364. The viscosity or flowability in part varies as a function of the magnetic field strength up to a certain point, as from which the fluid is solidified to a maximum extent.

The particular advantage of the invention is that it is no longer necessary to have movable parts such as valves or the like in order to restrict or shut off the fluid line and consequently there is no longer any wear. The solidification of the fluid by producing a magnetic field and also the discontinuance thereof does not stress the magnetorheological fluid with respect to fatigue or the like.

Advantageously the rod chamber is located behind the clamping rod in the body. It can virtually be located in the extension thereof. If the rod guide has an elongated guide channel in which the clamping rod passes in sealed manner and which as a result has the same cross-sections, a rod chamber can be formed by a rear portion of the guide channel. In particular it can so-to-speak be a portion thereof.

The channel to which a rod chamber is connected advantageously has a smaller cross-section than the rod chambers, particularly with respect to the passage cross-section for the fluid or a fluid path. As a result channel blocking by fluid solidification can take place in a particularly advantageous manner.

For producing the magnetic field it is possible to provide a magnet with a magnet yoke structure. The latter serves to introduce the magnetic field into the channel or into its area or concentrate the same therein. A magnet yoke, which can e.g. comprise laminated soft magnetic plates, guides the magnetic field or magnetic field lines concentrating them in certain areas. Advantageously the magnetic field runs transversely to the channel. However, the magnetic field direction is not important for the action on the magnetorheological fluid.

Magnetic field production is advantageously activatable and deactivatable, depending on whether a clamping rod is to be locked or movable. It is possible to use permanent magnets, which can e.g. engage on one another and be mutually displaced in such a way that the resulting overall magnetic field is either cancelled out or strengthened. It is also possible to have a movable arrangement with at least one permanent magnet and a movable soft iron core or a variable magnet yoke structure. In the clamping rod locking position the magnetic field lines pass through the closed magnet yoke structure and the channel. In the open rod position the magnetic field lines are short-circuited by a soft iron core without a magnetic field through the channel. Permanent magnets permit a completely self-sufficient, freely handleable use.

An electromagnet can be used as an alternative to a permanent magnet, permitting easy electrical control, whilst also having no movable parts.

Advantageously a clamping jaw has several clamping rods on the same body. In particularly advantageous manner at least two and in particular all the clamping rods are parallel and run in the same direction. All the clamping rods of a body can form the clamping side. It is also advantageous for the clamping rods to be arranged in rows and for several clamping rod rows to be juxtaposed in parallel. This makes it possible to create an extended clamping rod field with which in wide limits randomly shaped workpieces can be clamped in relatively precisely adjustable manner. The mutual spacings of the clamping rods can be identical for a uniformly distributed arrangement and therefore clamping effect. However, it is also possible to have different spacings, particularly also partially differing directions of the clamping rods.

It is possible to make one or a few clamping rods fixable by a separate locking device. This makes it possible to create predeterminable stop points for a workpiece, whereas over the remaining lockable clamping rods the workpiece can be clamped in conformal manner for the particular machining operation.

At least two clamping rods should in each case be linked by a closed system of in each case one rod chamber and a channel between the same. This system is filled with magnetorheological fluid and is advantageously completely closed. Through a fluid-carrying communication between the rod chambers via the channels, the pressing in of one clamping rod brings about the forcing out of one or more clamping rods. According to a further development it is also possible to provide a separate compensating chamber, which can e.g. be separately connected in. This makes possible a simultaneous adjustment of all the clamping rods, e.g. so that in the case of fixed clamping jaws much smaller or larger workpieces can be allowed for.

Advantageously there is a coupling and common locking device for each system of linked rod chambers and channels. It is possible either to jointly connect groups of clamping rods of one clamping jaw and for fixing to take place by a locking device provided for the same. Alternatively all the clamping rods of a clamping jaw can have a joint locking device. Here the fixing of the clamping rods is particularly simple. For this it is possible for said single, joint locking device to simultaneously act on a single, intercommunicating system of all rod chambers and all channels.

For the construction of the clamping jaw it is possible to provide on the body in which the rod guides can be worked a plate-like channel body on the back of the clamping rod. Said channel body covers the body and has through holes and/or recesses, which can be used for interlinking the rod chambers. It is also possible here to make such a channel body replaceable and, independently of the arrangement of the holes and recesses, to create different groups of rod chambers intercommunicating as a system, as a function of the desired application.

It is also possible to place on the channel body a back plate, which seals the said body to the outside. It can also have recesses through which it is possible to influence the fluid line between individual rod chambers.

When producing a magnetic field with projecting pole shoes the latter can engage in a channel body or in a back plate, which makes it readily possible to couple in the magnetic field. The pole shoes can face one another in such a way that the channel body or the channels or recesses, e.g. also part of the rod chambers, are located in the action area of magnetic field production and the fluid can be solidified therein. For further magnetic field productions with further pole shoes, it is possible to have a distributed arrangement thereof.

A clamping jaw of the above-described type can be provided for a clamping device according to the invention. For a workpiece there is a need for a counterclamping device against which the workpiece is pressed. This is advantageously also shape-deformable and adaptable to the workpiece contour. In particularly advantageous manner it is also an above-described clamping jaw.

At least one of said clamping jaws can be mounted on a displaceable holder in the case of a clamping device. The holder can be displaceable in the longitudinal direction of the clamping rod and locked at a random location. This not only permits an adaptation to different workpieces, but it is also possible in the case of a batch of identical workpieces in in each case the same clamping position to set the workpiece contour once and for all by means of the clamping rod. By means of a displacement along the holder it is then possible to clamp and unclamp individual workpieces. For workpieces with a particularly complicated construction or those where the machining direction varies greatly, a more than two-sided clamping takes place. For this purpose three or four clamping jaws are provided and are oriented towards an area or point. This permits an all-round clamping of the workpiece. According to a further development clamping jaws can be oriented not only within one plane, but virtually from all sides with respect to a workpiece.

These and further features can be gathered from claims, description and drawings and individual features, both singly or in the form of subcombinations, can be implemented in an embodiment of the invention and in other fields and can represent advantageous, independently protectable constructions for which protection is claimed here. The subdivision of the application into individual sections and the subheadings in no way restrict the general validity of the statements made thereunder.

### BRIEF DESCRIPTION OF THE DRAWINGS

An embodiment of the invention is described in greater detail hereinafter relative to the diagrammatic drawings, wherein show:

FIG. 1 A clamping device according to the invention with two facing clamping jaws with in each case clamping rods, whose movability can be influenced by a magnetorheological fluid.

FIG. 2 A section through the clamping jaw body at A-A.

### DETAILED DESCRIPTION OF THE EMBODIMENT

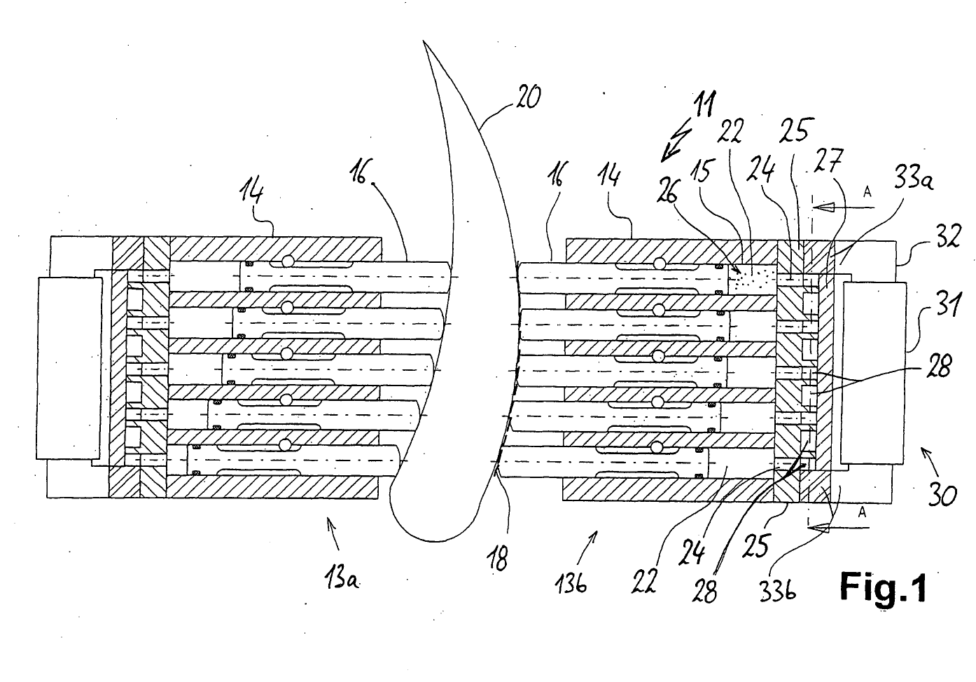

FIG. 1 shows a clamping device 11 comprising two facing clamping jaws 13a, 13b, which can be moved towards one another. The clamping jaws 13 have linearly displaceable clamping rods 16 guided in rod guides 15. The rods 16 form with their rounded front sides an envelope, which can be looked upon as a clamping side 18 and which is shown in broken line form. In the embodiment shown the rods 16 of both clamping jaws 13a, 13b in each case engage on two sides of a workpiece 20, which has a double curved cross-section. The clamping rods 16 or the clamping sides 18 formed by them engage on the surfaces of workpiece 20 in such a way that by the fixed engagement of each clamping rod it is firmly and immovably clamped thereto.

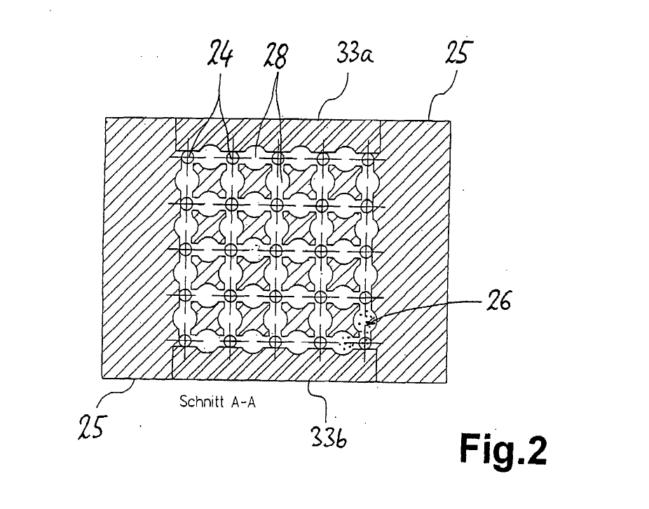

At the rear end of clamping rods 16 rod chambers 22 are provided in the rod guides 15 and their size is dependent on the extent to which a rod 16 has been inserted in or extracted from the rod guide 15. By means of channels 24 and depressions in a channel plate 25, which is applied to the body 14 from the rear, a connecting or fluid path passes between the rod chambers. The magnetorheological fluid 26 is shown in dotted line form. So as not to overburden representation it is not shown in the other chambers or channels. There is also a cover plate 27 placed on channel plate 25. Details of channel plate 25 can be gathered from FIG. 2.

The rod chambers 22 of all the rods 16 or rod guides 15 are interconnected via channels 24 and depressions 28 in channel plate 25 in the manner of a so-called fluid-communicating system. It must also be borne in mind that this system is advantageously closed or sealed to the outside. It is filled with magnetorheological fluid 26 in a complete manner without air inclusions or the like. This means that in a free state of rods 16, i.e. without workpiece 20, e.g. on pressing in a rod 16 the fluid is forced out of the associated rod chamber 22 through channel 24. As a result via channel plate 25 with depressions 28 and other channels 24 the fluid is forced into one or more rod chambers 22 and consequently one or more other clamping rods 16 are pressed out. Thus, all the rods 16 of a clamping jaw 13 are interconnected and the movement of one rod gives rise to the movement of at least one other rod. In place of a complete connection between all the clamping rods 16 of a clamping jaw 13, it is also possible to interconnect only specific groups of clamping rods, but these groups cannot be connected to other groups, this depending on how clamping is to be made possible.

In order e.g. with a workpiece 20 clamped to fix the contour of the clamping side 18 or the position of the individual clamping rods 16, an electromagnet 30 is provided. It comprises a set of windings 31 provided around a core 32 with pole shoes 33a, 33b. The pole shoes 33 run into the channel plate 25, as can be readily gathered from FIG. 2. The channel plate 25 is made from a material which conducts magnetic field lines particularly well, especially soft iron. It can give rise to a magnetic flux, which is produced by the activation of electromagnet 30, between the pole shoes 33 and therefore through channel plate 25. If permanent magnets are used they can replace the electromagnet. They could be displaceable with respect to one another so as to either produce or cancel out a resulting magnetic field.

This application of a magnetic field leads to a marked rise in the viscosity or sudden solidification of the magnetorheological fluid 26, which is contained in the depressions 28 and the adjacent channels 24 of channel plate 25. As a result the fluid-conducting communication between the rod chambers 22 is stopped or blocked, so that the clamping rods 16 can no longer be moved.

For comparison purposes it can be stated that the application of a magnetic field in the above-described manner to the depressions 28 and channels 24 or the fluid therein has the same effect as if they were closed by valves. Thus, by simply activating electromagnet 30 the complete clamping jaw 13 or all the rods 16 are fixed in the instantaneous position.

If the electromagnet 30 is disconnected and the magnetic field is no longer present, the fluid is once again fully movable in the communicating system. Rods 16 are again freely movable in the manner described hereinbefore.

This makes it possible for the clamping jaws 30, which can be moved towards and away from one another on linear guides, to be moved up to a workpiece 20 with sufficient force to enable the clamping side 18 formed by rods 16 to adapt to the workpiece contour. The clamping jaws 13 can then be fixed in their guides and simultaneously fix the shape of the clamping side 18 through the activation of electromagnet 30. Thus, the specific workpiece 20 is firmly clamped. A further major advantage is that following the machining of workpiece 20, the fixing of rods 16 is maintained instead of being cancelled out. Thus, the clamping jaws 13 maintain their precisely predetermined contour of clamping side 18. Workpiece 20 can be removed by moving away a clamping jaw 13. Another workpiece with the same shape can be clamped in precisely the same way, in that it is placed between the clamping jaws 13a, 13b, which are again moved together and fixed. Thus, the invention creates a clamping device having clamping jaws and the clamping side contour can be randomly adjusted and fixed without using valves or the like.

Through the fixing of the rods 16 by the communicating fluid system with the magnetorheological fluid 26, which solidifies by applying a magnetic field, there is no need for the otherwise necessary parts such as valves, shut-off valves, etc. Otherwise one valve would be necessary for each rod 16, which in particular with a clamping jaw 13 according to the embodiment would with in all twenty five rods represent a considerable expenditure. The replacement of defective valves would also be very time-consuming as a result of the high density demands and the high mechanical forces which occur.

In the plan view of channel plate 25 in FIG. 2, it can be seen how the channels 24 are arranged. It is also possible to see the depressions 28 with which the channels 24 are connected so as to produce a completely linked system.

1. Clamping jaw for a clamping device for clamping a workpiece, said clamping jaw having a body and a clamping side to be applied to said workpiece to be clamped, said clamping side being formed by at least one clamping rod displaceable relative to said body in a rod guide and being applicable to a contour of said workpiece, said clamping rod being releasably and displaceably lockable by means of a locking device, said clamping jaw having a working fluid flowing from a rod chamber through a channel to a further rod chamber, said further rod chamber having a volume-variability through clamping rod movement, said volume-variability being limited by constricting or blocking said channel for locking said clamping rod, wherein said working fluid is a magnetorheological fluid and said locking device has a magnetic field production means with a magnetic action area including said channel.

2. Clamping jaw according to claim 1, wherein said rod chamber is provided behind said clamping rod in said body roughly in longitudinal direction of said clamping rod.

3. Clamping jaw according to claim 1, wherein one said rod guide has an elongated guide channel in which is longitudinally displaceably mounted on said clamping rod in cylinder-like form.

4. Clamping jaw according to claim 1, wherein a cross-section of said channel is smaller than a cross-section of one of said rod chambers.

5. Clamping jaw according to claim 1, wherein said magnetic field production means or a magnet with a magnetic yoke structure concentrates said magnetic field through said channel and therein.

6. Clamping jaw according to claim 1, wherein said magnetic field production means is an activatable and deactivatable electromagnet.

7. Clamping jaw according to claim 22, wherein least two said permanent magnets are provided and are positioned so that resulting magnetic field is either cancelled out or strengthened by movement or displacement against one another.

8. Clamping jaw according to claim 22, wherein a movable arrangement is provided with at least one said permanent magnet and a movable soft iron core, wherein in a locking position magnetic field lines of said permanent magnet pass through a closed magnet yoke structure and said channel and wherein in an open position said magnetic field lines are short-circuited by a said soft iron core without a magnetic field in said channel.

9. Clamping jaw according to claim 1, wherein there are provided several clamping rods on said body and at least two said clamping rods are directed in same direction forming said clamping side.

10. Clamping jaw according to claim 9, wherein at least two said clamping rods in each case have one said rod chamber and said two rod chambers are interconnected by at least one said channel and in a closed system of said rod chambers and said channel is located the said magnetorheological fluid, said mobility of said two clamping rods being such that through displacement of said magnetorheological fluid from one said rod chamber, via said channel to the other said rod chamber a pressing in of one of said clamping rods forces out said other clamping rod.

11. Clamping jaw according to claim 9, wherein there are several said clamping rods in a row and several rows of said clamping rods are provided in parallel, juxtaposed manner as an extended field of said clamping rods.

12. Clamping jaw according to claim 9, wherein several said clamping rods are provided, in each case at least two said clamping rods are coupled together in their mobility via a communicating system of said rod chambers and said channels with said magnetorheological fluid therein.

13. Clamping jaw according to claim 12, wherein all said clamping rods are linked by a single, intercommunicating system, being lockable by means of a single locking device for locking all said clamping rods in a specific position.

14. Clamping jaw according to claim 1, wherein a plate-like channel body is provided on said body directed away from said clamping rods and a base surface of said plate-like channel body roughly corresponds to that of said body, said plate-like channel body having through holes or recesses in each case connected to one said rod chamber.

15. Clamping jaw according to claim 14, wherein on said plate-like channel body is provided a back plate being at least closed on back surface and having depressions interconnecting in fluid-conducting manner several of said channels of said channel body.

16. Clamping jaw according to claim 15, wherein pole shoes of an electromagnet are provided engaging in said channel body or said back plate for producing a magnetic field, said pole shoes facing one another with spatially distributed channels or depressions between them.

17. Clamping jaw according to 1, wherein said intercommunicating, fluid-conducting system of said rod chambers and said channels is sealed to an outside and its overall volume is invariable.

18. Clamping device with at least one clamping jaw according to claim 1, wherein with said clamping jaw is associated a counterclamping device for clamping a workpiece.

19. Clamping device according to claim 18, wherein at least one of said clamping jaws is longitudinally displaceable in a longitudinal direction of said clamping rod and lockable in a specific position on a displaceable holder.

20. Clamping device according to claim 18 wherein there are at least three said clamping jaws according to claim 1, said clamping jaws being distributed in ring-like manner.

21. Clamping jaw according to claim 3, wherein said rod chamber is formed by a portion of said guide channel.

22. Clamping jaw according to claim 1, wherein said magnetic field production means comprises at least a permanent magnet.

23. Clamping jaw according to claim 12, wherein there is provided a single locking device for all said clamping rods.

24. Clamping device according to claim 18, wherein said counterclamping device is a further clamping jaw according to claim 1.
